(19) United States
(12) Patent Application Publication
(10) Pub. No.: US 2014/0340420 A1
(43) Pub. Date: Nov. 20, 2014

(54) HYBRID DISPLAY DEVICE AND DISPLAYING METHOD THEREOF

(71) Applicant: Electronics and Telecommunications Research Institute, Daejeon (KR)

(72) Inventors: Jun-Han HAN, Daejeon (KR); Jeong Ik LEE, Daejeon (KR); Hye Yong CHU, Daejeon (KR); Jonghee LEE, Daejeon (KR); Jong Tae LIM, Seoul (KR)

(73) Assignee: Electronics and Telecommunications Research Institute, Daejeon (KR)

(21) Appl. No.: 14/192,913

(22) Filed: Feb. 28, 2014

(30) Foreign Application Priority Data
May 15, 2013 (KR) 10-2013-0055204

(51) Int. Cl. G06T 1/00; G09G 5/00

(52) U.S. Cl. CPC G06T 1/00; G09G 5/00
USPC 345/619; 345/204

(57) ABSTRACT

Provided is a display device including a pixel array configured to include a reflective pixel unit including one or more reflective sub pixels and an emissive pixel unit including one or more emissive sub pixels, wherein the reflective pixel unit and the emissive pixel unit are combined to allow the reflective sub pixel and the emissive sub pixel to be included in one coordinate; an image determination circuit configured to generate a determination signal according to a characteristic of an image; a gate driver configured to generate a gating signal for activating at least one of the reflective sub pixel and the emissive sub pixel in one coordinate based on to the generated determination signal; and a data driver configured to provide a driving signal to the pixel array by referring to image data and the generated gating signal.

### CROSS-REFERENCE TO RELATED APPLICATIONS

This U.S. non-provisional patent application claims priority under 35 U.S.C. §119 of Korean Patent Application No. 10-2013-0055204, filed on May 15, 2013, the entire contents of which are hereby incorporated by reference.

### BACKGROUND OF THE INVENTION

1. Technical Field

The inventive concept disclosed herein relates to display technique, and more particularly, to a hybrid display device comprising a reflective display and an emissive display, and a displaying method thereof.

2. Description of Related Art

Types of driving a display device are classified as a transmissive one, an emissive one, and a reflective one.

A transmissive display device is a device that does not emit light by itself and displays a screen by adjusting the amount of transmission of light emitted from a backlight. Examples of the transmissive display device include a LCD (Liquid Crystal Display) device, and so on. The transmissive display device has clear color contrast and provides an image having clear image quality. However, the transmissive display device has high power consumption, and has a limitation in implementing a flexible display device.

An emissive display device is a display device emitting light from a pixel itself to display a screen. Examples of the emissive display device include an OLED (Organic Light Emitting Diode) display device, a PDP (Plasma Display Panel) display device, and so on. The emissive display device emits light by itself, so that it has fast response speed, high contrast, and excellent color reproduction. However, the emissive display device has higher power consumption than that of a reflective display device, and has less visibility in bright environment.

The reflective display device is a device that does not have an additional light source, and displays a screen by reflecting external light such as sunlight or lighting from light sources. Examples of the reflective display device include an EPD (Electro-Phoretic Display) device, an EWD (Electro-Wetting Display) device, a PCD (Photonic Crystal Display) device, MEMS (Micro Electro-Mechanical System), and so on. The reflective display device uses external light so that it has excellent visibility in bright environment, and has less power consumption. However, the reflective display device has a limitation of application due to low color reproduction. Moreover, the reflective display device has slower pixel response speed compared to other types of display devices, so that it shows poor performance when it displays a moving image.

That is, a display device providing a clear image without being affected by external light and having less power consumption and flexibility is needed.

### SUMMARY OF THE INVENTION

The inventive concept provides a hybrid display device combining at least one reflective pixel and at least one emissive pixel. In order to overcome limitations of a reflective display type, an emissive display type is used in a limited way. This is to utilize the strengths of two display types. However, a display area is divided depending on a property of an image to be outputted. Additionally, an image is outputted by a reflective pixel in a specific area and an image is outputted by an emissive pixel in another specific area.

One embodiment of the inventive concept may provide a display device including a pixel array configured to include a reflective pixel unit including one or more reflective sub pixels and an emissive pixel unit including one or more emissive sub pixels, wherein the reflective pixel unit and the emissive pixel unit are combined to allow the reflective sub pixel and the emissive sub pixel to be included in one coordinate; an image determination circuit configured to generate a determination signal according to a characteristic of an image to be outputted to each of the coordinates; a gate driver configured to generate a gating signal for activating at least one of the reflective sub pixel and the emissive sub pixel in one coordinate based on the generated determination signal; and a data driver configured to provide a driving signal to the pixel array by referring to image data to be outputted to each of the coordinates and the generated gating signal.

In one embodiment, the display device may further include a timing controller configured to control output of the image data to be outputted to each of the coordinates by distributing the generated determination signal and a signal corresponding to the image data into the gate driver and the data driver.

In one embodiment, the data driver may drive the reflective sub pixel at an operating frequency lower than that of the emissive sub pixel.

In one embodiment, the determination signal may be generated by determining whether a content of the image to be outputted to each of the coordinates is a still image or a moving image.

In one embodiment, the reflective sub pixel may be activated and the emissive sub pixel may be deactivated at a coordinate where a still image is to be outputted, and the emissive sub pixel may activated and the reflective sub pixel may be deactivated at a coordinate where a moving image is to be outputted, in response to the generated gating signal.

In one embodiment, the determination signal may be generated by determining whether a content of the image to be outputted to each of the coordinates is an interface for input of user or an ordinary standby screen.

In one embodiment, the reflective sub pixel may be activated and the emissive sub pixel may be deactivated at a coordinate where an ordinary standby screen is to be outputted, and the emissive sub pixel may be activated and the reflective sub pixel may be deactivated at a coordinate where an interface for input of user is to be outputted, in response to the generated gating signal.

In one embodiment, the reflective sub pixel may be activated and the emissive sub pixel may be deactivated at a coordinate where an ordinary standby screen is to be outputted, and the emissive sub pixel may be activated regardless of whether the reflective sub pixel is activated or not at a coordinate where an interface for input of user is to be outputted, in response to the generated gating signal.

Other embodiment of the inventive concept may provide a screen displaying method including generating a determination signal by referring to a characteristic of an image to be outputted, with respect to each of coordinates of pixels of a display device; generating a gating signal for activating at least one of the reflective sub pixel and the emissive sub pixel in each of the coordinates based on the generated determination signal; and activating at least one of the reflective sub pixel and the emissive sub pixel at each of the coordinates according to the generated gating signal.

In other embodiment, the reflective sub pixel may be driven at an operating frequency lower than that of the emissive sub pixel.

In other embodiment, the determination signal may be generated by determining whether a content of the image to be outputted to each of the coordinates is a still image or a moving image.

In other embodiment, the reflective sub pixel may be activated and the emissive sub pixel may be deactivated at a coordinate where a still image is to be outputted, and the emissive sub pixel may be activated and the reflective sub pixel may be deactivated at a coordinate where a moving image is to be outputted, in response to the generated gating signal.

In other embodiment, the determination signal may be generated by determining whether a content of the image to be outputted to each of the coordinates is an interface for input of user or an ordinary standby screen.

In other embodiment, the reflective sub pixel may be activated and the emissive sub pixel may be deactivated at a coordinate where an ordinary standby screen is to be outputted, and the emissive sub pixel may be activated and the reflective sub pixel may be deactivated at a coordinate where an interface for input of user is to be outputted, in response to the generated gating signal.

In other embodiment, the reflective sub pixel may be activated and the emissive sub pixel may be deactivated at a coordinate where an ordinary standby screen is to be outputted, and the emissive sub pixel may be activated regardless of whether the reflective sub pixel is activated or not at a coordinate where an interface for input of user is to be outputted, in response to the generated gating signal.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIGS. 1A and 1B are conceptual diagrams illustrating a configuration of a pixel array according to an embodiment of the inventive concept;

FIG. 2 is a block diagram illustrating a configuration of a display device according to an embodiment of the inventive concept;

FIGS. 3A and 3B are block diagrams illustrating another configuration of a display device according to an embodiment of the inventive concept;

FIG. 4 is a conceptual diagram illustrating characteristics of an image displayed on a display device according to an embodiment of the inventive concept;

FIG. 5 is a flowchart illustrating a screen displaying method according to other embodiment of the inventive concept;

FIG. 6 is a detailed flowchart illustrating a screen displaying method according to other embodiment of the inventive concept;

FIG. 7 is a detailed flowchart illustrating another screen displaying method according to other embodiment of the inventive concept; and

FIG. 8 is a detailed flowchart illustrating other screen displaying method according to other embodiment of the inventive concept.

### DETAILED DESCRIPTION OF PREFERRED EMBODIMENTS

The above-mentioned characteristics and description below are exemplary details for helping the description and understanding of the inventive concepts. That is, the inventive concepts are not limited to such embodiments and are specified in other forms. The next embodiments are exemplary in order to completely disclosure the inventive concepts, and to deliver the inventive concepts to those skilled in the art that the inventive concepts belongs. Accordingly, when there are several methods for realizing components of the inventive concepts, it is needed to clarify that any one of specific methods or identical methods can be used to realize the inventive concepts.

In this specification, when it is mentioned that a certain configuration include specific components, or a certain process include specific steps, it means that there are more other components or other steps. That is, terms used in this specification are used for just explaining specific embodiments, and do not limit the inventive concepts. Furthermore, an embodiment described and exemplified herein includes complementary embodiments thereof.

Terms used in this specification have the meanings that those skilled in the art generally understand. Generally used terms should be understood as consistent meanings according to the context of this specification. Additionally, when terms used in this specification are not clearly defined, they should not be interpreted as overly ideal or formal meanings. Embodiments of the inventive concepts will be described in more detail with reference to the accompanying drawings.

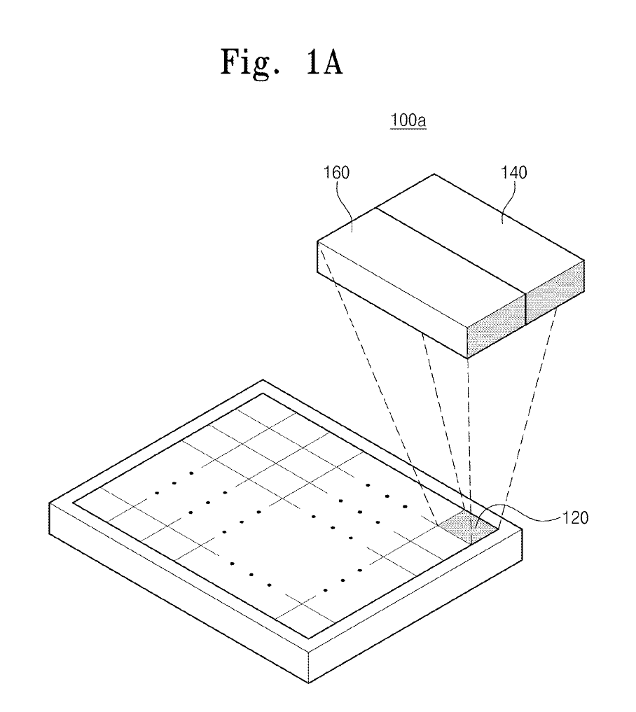

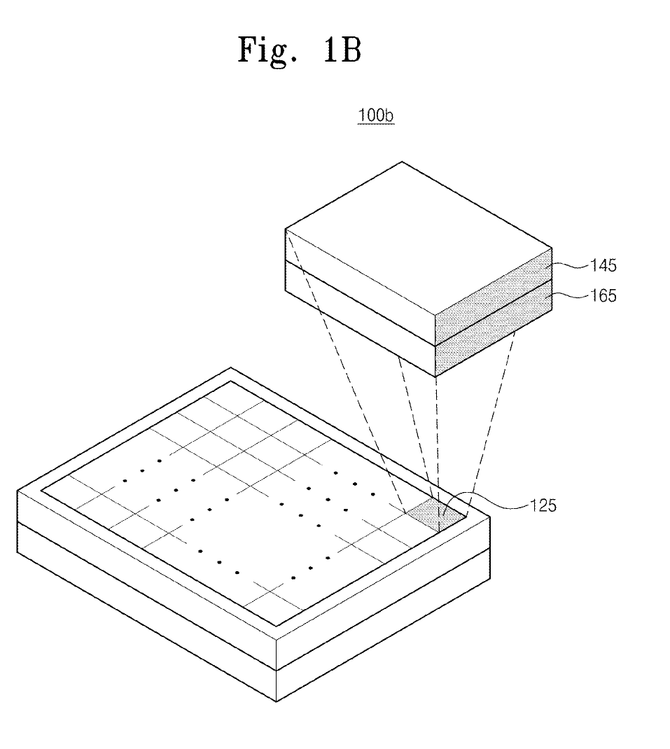

FIGS. 1A and 1B are conceptual diagrams illustrating a configuration of a pixel array according to an embodiment of the inventive concept. Pixel arrays 100a and 100b are formed of pixels 120 and 125, respectively. FIG. 1A illustrates the case that the pixel 120 includes one layer and FIG. 1B illustrates the case that the pixel 125 includes a plurality of layers.

As shown in FIG. 1A, the pixel 120 including one layer includes a reflective sub pixel 140 and an emissive sub pixel 160. The reflective sub pixel 140 and the emissive sub pixel 160 is arranged on different areas in one layer.

As shown in FIG. 1B, the pixel 125 including a plurality of layers includes a reflective sub pixel 145 and an emissive sub pixel 165. The reflective sub pixel 145 and the emissive sub pixel 165 are arranged on different layers. FIG. 1B illustrates that the reflective sub pixel 145 is disposed on the emissive sub pixel 165. In this case, when the reflective sub pixel 145 is not activated, it has a transparent state. However, it is apparent to those skilled in the art that the emissive sub pixel 165 may be disposed on the reflective sub pixel 145. In this case, when the emissive sub pixel 145 does not emit light, it has a transparent state.

As shown in FIGS. 1A and 1B, one or more reflective sub pixels 140 or 145 form a reflective pixel unit, and one or more emissive sub pixels 160 or 165 form an emissive pixel unit. Each pixel 120 or 125 has one coordinate, and the reflective sub pixel 140 or 145 and the emissive sub pixel 160 or 165 correspond to the one coordinate. The reflective pixel unit and the emissive pixel unit are combined to allow the reflective sub pixel 140 or 145 and the emissive sub pixel 160 or 165 to be included in one coordinate.

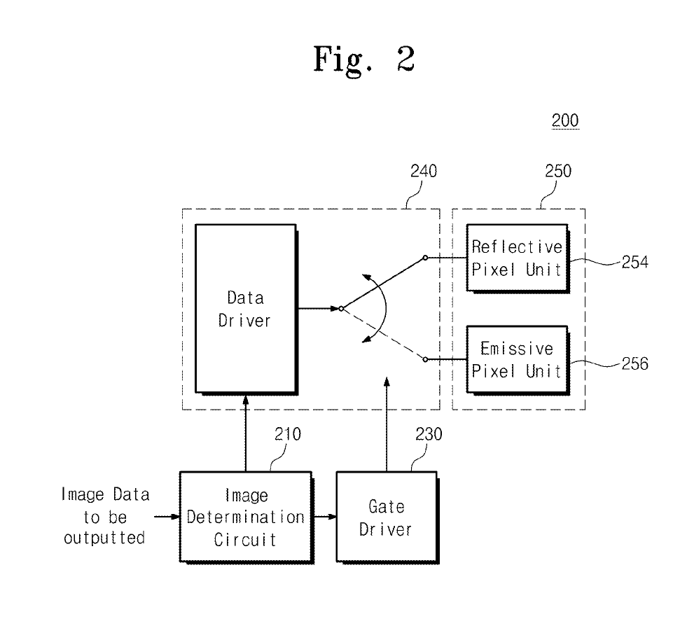

FIG. 2 is a block diagram illustrating a configuration of a display device according to an embodiment of the inventive concept. A display device 200 of FIG. 2 includes an image determination circuit 210, a gate driver 230, a data driver 240, and a pixel array 250.

The pixel array 250 includes a reflective pixel unit 254 and an emissive pixel unit 256. A configuration and functions of the pixel array 250 are identical to those of the pixel array 100 shown in FIG. 1. That is, the reflective sub pixel 140 or 145 may form the reflective pixel unit 254 and the emissive sub pixel 160 or 165 may form the emissive pixel unit 256.

The image determination circuit 210 receives image data to be outputted. The image determination circuit 210 determines a characteristic of an image to be outputted to each of coordinates of the pixels 120 or 125. Then, the image determination circuit 210 generates a determination signal corresponding to a determination result. A determination signal, a signal corresponding to information of a determination target coordinate, and a signal corresponding to image data to be outputted to the determination target coordinate may be provided to the gate driver 230 and the data driver 240.

For instance, the determination signal is generated by determining whether a characteristic of an image to be outputted to each of the coordinates is a still image or a moving image. In this instance, the image determination circuit 210 generates a voltage level corresponding to a digital value 0 if the characteristic of the image to be outputted to each of the coordinates is a still image, and generates a voltage level corresponding to a digital value 1 if the characteristic of the image to be outputted to each of the coordinates is a moving image.

For other instance, the determination signal is generated by determining whether a characteristic of an image to be outputted to each of the coordinates is an interface for input of user or an ordinary standby screen. The interface for input of user refers to a reaction result, for example, a notification screen for input such as screen touch. The ordinary standby screen refers to a standby screen such as a background displayed regardless of input of user. The image determination circuit 210 generates a voltage level corresponding to a digital value 0 when the characteristic of the image to be outputted to each of the coordinates is an ordinary standby screen, and generates a voltage level corresponding to a digital value 1 when the characteristic of the image to be outputted to each of the coordinates is an interface for input of user.

The gate driver 230 generates a gating signal according to the determination signal. The gating signal is a signal for activating at least one of the reflective sub pixel 140 or 145 and the emissive sub pixel 160 or 165 in one coordinate. In response to the gating signal, one of the reflective sub pixel 140 or 145 and the emissive sub pixel 160 or 165 in one coordinate may be selectively activated. Alternatively, in response to the gating signal, the reflective sub pixel 140 or 145 and the emissive sub pixel 160 or 165 in one coordinate may be activated simultaneously.

For instance, when a voltage level corresponding to a digital value 0 is generated with respect to a characteristic of an image to be outputted to a specific coordinate, the gating signal is generated so as to activate the reflective sub pixel 140 or 145 with respect to the specific coordinate. On the other hand, when a voltage level corresponding to a digital value 1, the gating signal is generated so as to activate the emissive sub pixel 160 or 165 with respect to the specific coordinate.

The gate driver 230 refers to the determination signal and a signal corresponding to information of coordinate. The gate driver 230 generates the gating signal for activating at least one of the reflective sub pixel 140 or 145 and the emissive sub pixel 160 or 165 with respect to each of the coordinates. The gating signal generated by the gate driver 230 is provided to the data driver 240.

For instance, the determination is generated by determining whether a characteristic of an image to be outputted to each of the coordinates is a still image or a moving image. In this instance, in response to the gating signal, the reflective sub pixel 140 or 145 is activated and the emissive sub pixel 160 or 165 is deactivated at a coordinate where the still image is to be outputted. On the other hand, in response to the gating signal, the emissive sub pixel 160 or 165 is activated and the reflective sub pixel 140 or 145 is deactivated at a coordinate where the moving image is to be outputted.

For other instance, the determination signal is generated by determining whether a characteristic of an image to be outputted to each of the coordinates is an interface for input of user or an ordinary standby screen. In this instance, in response to the gating signal, the reflective sub pixel 140 or 145 is activated and the emissive sub pixel 160 or 165 is deactivated at a coordinate where the ordinary standby screen is to be outputted. On the other hand, in response to the gating signal, the emissive sub pixel 160 or 165 is activated and the reflective sub pixel 140 or 145 is deactivated at a coordinate where the interface for input of user is to be outputted.

However, the reflective sub pixel 140 or 145 and the emissive sub pixel 160 or 165 may be activated simultaneously by properly controlling the gating signal. For instance, in response to the gating signal, the emissive sub pixel 160 or 165 may be activated regardless of whether the reflective sub pixel 140 or 145 is activated or not at a coordinate where the interface for input of user is to be outputted.

The data driver 240 provides a drive signal to the pixel array 250 by referring to the image data to be outputted to each of the coordinates and the gating signal. The data driver 240 receives the image data to be outputted to each of the coordinates. According to the display device of FIG. 2, the data driver 240 receives the image data to be outputted through the image determination circuit 210. However, it is apparent that the data driver 240 may include a circuit configured to directly receive the image data from an external device such as a video card.

Also, the data driver 240 provides the drive signal to a sub pixel to be activated by the gating signal, so that the image data is outputted to the sub pixel. The drive signal may be selectively provided to one of the reflective sub pixel 140 or 145 and the emissive sub pixel 160 or 165. However, the drive signal may be simultaneously provided to the reflective sub pixel 140 or 145 and the emissive sub pixel 160 or 165.

The data driver 240 may drive the reflective sub pixel 140 or 145 at an operating frequency lower than that of the emissive sub pixel 160 or 165. For instance, the emissive sub pixel 160 or 165 may be driven to enable fast screen switching at a high operating frequency such as about 60 Hz or about 120 Hz. On the other hand, the reflective sub pixel 140 or 145 may be driven to display a still image at a low operating frequency such as about 30 Hz or about 20 Hz.

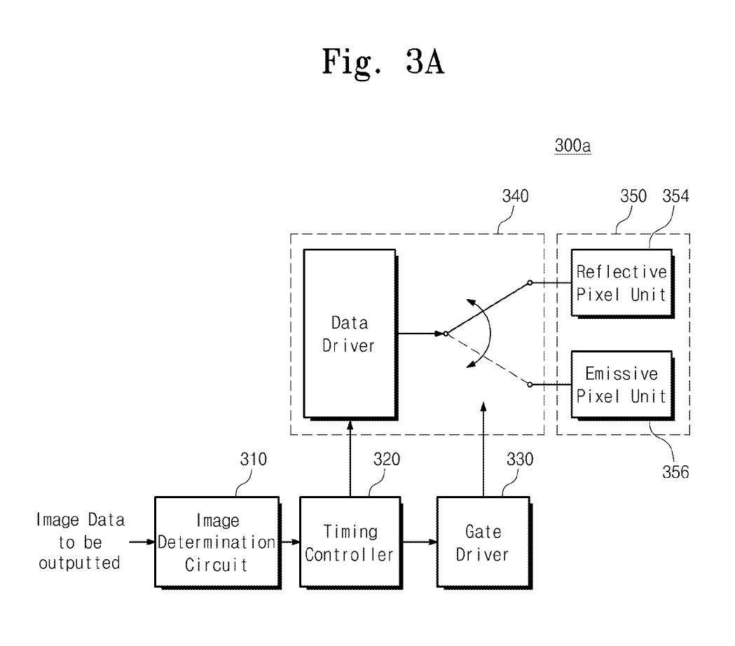

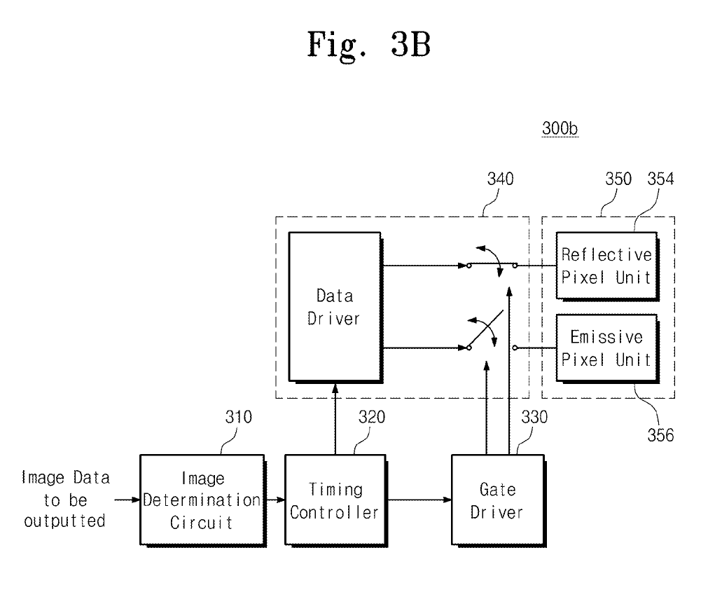

FIGS. 3A and 3B are block diagrams illustrating another configuration of a display device according to an embodiment of the inventive concept. Each of a display device 300a of FIG. 3A and a display device 300b of FIG. 3B includes an image determination circuit 310, a timing controller 320, a gate driver 330, a data driver 340, and a pixel array 350.

The pixel array 350 includes a reflective pixel unit 354 and an emissive pixel unit 356. A configuration and functions of the pixel array 350 are identical to those of the pixel array 100 of FIG. 1. That is, the reflective sub pixels 140 or 145 may form the reflective pixel unit 354 and the emissive sub pixels 160 or 165 may form the emissive pixel unit 356.

Functions of the image determination circuit 310, the gate driver 330, and the data driver 340 are identical to those of the image determination circuit 210, the gate driver 230, and the data driver 240 of FIG. 2. Detailed descriptions for the image determination circuit 310, the gate driver 330, and the data driver 340 are omitted.

The timing controller 320 receives a determination signal generated by the image determination circuit 310 and a signal corresponding to image data to be outputted to each of coordinates. The timing controller 320 controls output of the image data by distributing the received signals into the gate driver 330 and the data driver 340. That is, the timing controller 320 is connected between the image determination circuit 310, the gate driver 330, and the data driver 340 to control the display device 300a or 300b. Particularly, the timing controller 320 may be configured to prevent a time difference while image data is outputted in a large-sized display device.

According to the display device 300a of FIG. 3A, a drive signal for the reflective sub pixel 140 or 145 and a drive signal for the emissive sub pixel 160 or 165 are provided along the same signal line. On the other hand, according to the display device 300b of FIG. 3B, the drive signal for the reflective sub pixel 140 or 145 and a drive signal for the emissive sub pixel 160 or 165 are provided along different signal lines. That is, the drive signal may be provided through various methods according to a configuration of a circuit. Except for such difference of a configuration, the display device 300a and 300b have the same functions and effects.

In the above-mentioned embodiments, descriptions are made on whether a characteristic of an image to be outputted to each of coordinates is a still image or a moving image, or an interface for input of user or an ordinary standby screen. However, it is apparent to those skilled in the art that a signal for determining a still image or a moving image and a signal for determining an interface for input of user or an ordinary standby screen may be generated simultaneously by properly designing a configuration of a circuit and signal processing procedure.

It is apparent to those skilled in the art that other standards other than a still image or a moving image, or an interface for input of user or an ordinary standby screen may be set as necessary. Furthermore, standards having three or more states other than standards having two states may be set. That is, the above embodiments are exemplary to describe the inventive concept.

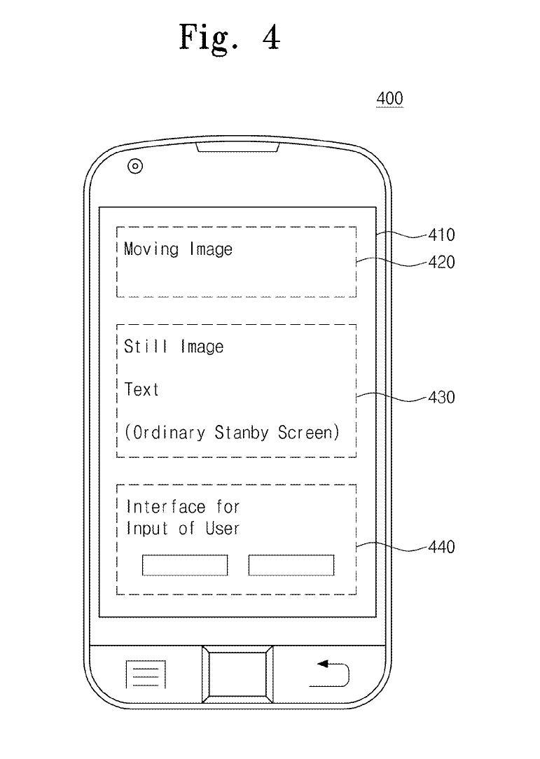

FIG. 4 is a conceptual diagram illustrating characteristics of an image displayed on a display device according to an embodiment of the inventive concept. The display device 400 of FIG. 4 includes a screen display area 410. The screen display area 410 includes a moving image display area 420, a still image, a text, and an ordinary standby screen display area 430, and an interface display area for input of user 440.

The emissive sub pixels 160 or 165 may be activated at the pixels 120 or 125, respectively, in coordinates of the moving image display area 420. The reflective sub pixels 140 or 145 may be activated at the pixels 120 or 125, respectively, in coordinates of the still image, the text, and the ordinary standby screen display area 430. The emissive sub pixels 160 or 165 may be activated at the pixels 120 or 125, respectively, in coordinates of the interface display area for input of user 440. The reflective sub pixels 140 or 145 may be activated at the pixels 120 or 125, respectively, in coordinates of a background area of the screen display area 140.

The reflective sub pixels 140 and 145 have less power consumption, and the emissive sub pixels 160 and 165 have fast response speed. Accordingly, it is better that the emissive sub pixels 160 or 165 is activated in coordinates displaying an image having a characteristic requiring fast screen switching, for example, an interface for input of user. On the contrary, it is better that the reflective sub pixels 140 or 145 are activated in coordinates displaying a still image, a text, an ordinary standby screen, and a background.

For other instance, the emissive sub pixels 160 or 165 may be activated regardless of whether the reflective sub pixels 140 or 145 are activated or not in the interface display area 440 for input of user. That is, the reflective sub pixels 140 or 145 and the emissive sub pixels 160 or 165 may be activated simultaneously at the pixels 120 or 125, respectively, in coordinates of the interface display area for input of user 440. In this case, the reflective sub pixels 140 or 145 and the emissive sub pixels 160 or 165 output different images. According to this instance, when the reflective sub pixels 140 or 145 and the emissive sub pixels 160 or 165 are driven at different operating frequencies, user's inconvenience due to slow response speed of the reflective sub pixels 140 and 145 may be relieved.

The moving image display area 420, the still image, the text, and the ordinary standby screen display area 430, and the interface display area for input of user 440 of FIG. 4 are arbitrarily set. Position of each area is not limited as described in FIG. 4, and may be changed according to a characteristic of an image to be outputted. Furthermore, each area may have different shape or may be omitted according to a characteristic of an image to be outputted.

The primary inventive concept is to drive at least one of the reflective sub pixels 140 or 145 and the emissive sub pixels 160 or 165 according to a characteristic of an image to be outputted to each of coordinates. The inventive concept reduces power consumption of a display device and clearly displays an image having a characteristic requiring fast screen switching.

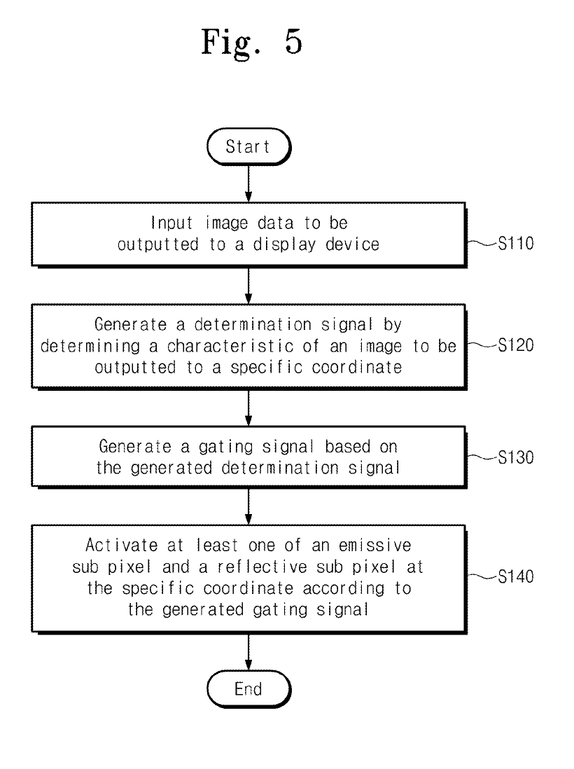

FIG. 5 is a flowchart illustrating a screen displaying method according to other embodiment of the inventive concept.

In operation S110, image data to be outputted is inputted to a display device. The image data to be outputted may be provided from an external device such as a video card connected to the display device. The display device may receive the image data to be outputted through an external input/output terminal.

In operation S120, a determination signal is generated by determining a characteristic of an image to be outputted at a specific coordinate in a screen display area of the display device. For instance, the determination signal may be generated by determining whether a characteristic of an image to be outputted to a specific coordinate is a still image or a moving image. For other instance, the determination signal may be generated by determining whether a characteristic of an image to be outputted to a specific coordinate is an interface for input of user or an ordinary standby screen.

In operation S130, a gating signal is generated based on the determination signal generated in the operation S120. The gating signal is a signal for activating at least one of a reflective sub pixel and an emissive sub pixel in the specific coordinate. In operation S130, a gating signal is generated to select a sub pixel to be activated among the reflective sub pixel and the emissive sub pixel according to the characteristic of the image to be outputted to the specific coordinate.

In operation S140, according to the gating signal generated in the operation S130, at least one of the reflective sub pixel and the emissive sub pixel is activated at the specific coordinate.

In this embodiment, the reflective sub pixel may be driven at an operating frequency lower than that of the emissive sub pixel. For instance, the emissive sub pixel may be driven at a high operating frequency such as about 60 Hz or about 120 Hz in order to enable fast screen switching. On the other hand, the reflective sub pixel may be driven at a low operating frequency such as about 30 Hz or about 20 Hz so as to display a still image.

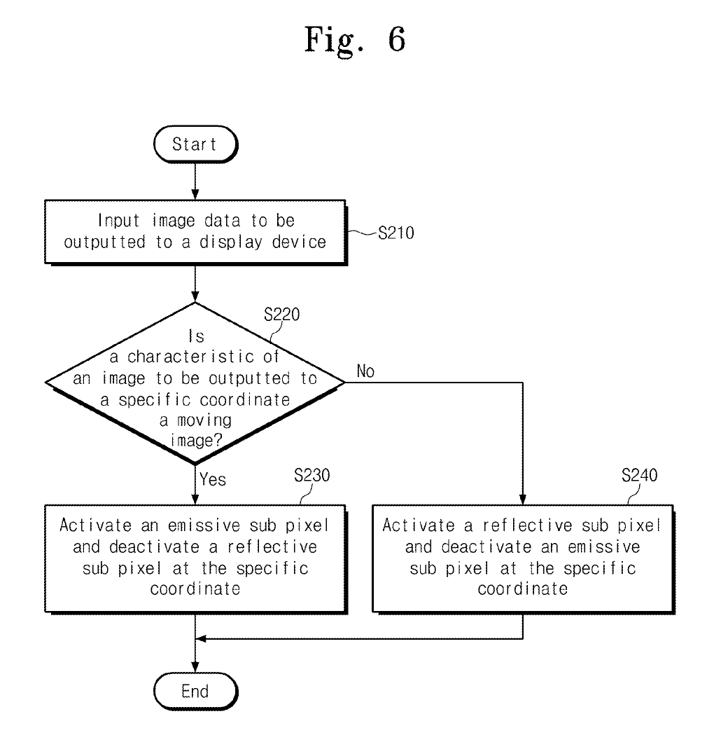

FIG. 6 is a detailed flowchart illustrating a screen displaying method according to other embodiment of the inventive concept. Particularly, FIG. 6 illustrates the case that a determination signal is generated by determining whether a characteristic of an image to be outputted to a specific coordinate is a still image or a moving image.

In operation S210, image data to be outputted is inputted to a display device. The image data to be outputted may be provided from an external device such as a video card connected to the display device. The display device may receive image data to be outputted through an external input/output terminal.

In operation S220, it is determined whether a characteristic of an image to be outputted at a specific coordinate in a screen display area of the display device is a moving image. According to whether the characteristic of the image to be outputted is a moving image or a still image, a sub pixel to be activated is selected among a reflective sub pixel and an emissive sub pixel included in the display device. When the characteristic of the image to be outputted is a still image, the method proceeds to operation S230, and when the characteristic of the image to be outputted is a moving image, the method proceeds to operation S240.

The operation S230 is performed when the characteristic of the image to be outputted to the specific coordinate is a moving image. In the operation S230, the emissive sub pixel is activated and the reflective sub pixel is deactivated at the specific coordinate. The emissive sub pixel has fast response speed, so that it fits for outputting a moving image.

The operation S240 is performed when the characteristic of the image to be outputted to the specific coordinate is a still image. In the operation S240, the reflective sub pixel is activated and the emissive sub pixel is deactivated at the specific coordinate. The emissive sub pixel has fast response speed, but it has high power consumption. Therefore, it is better that the reflective sub pixel having less power consumption is activated at a coordinate where a still image is outputted.

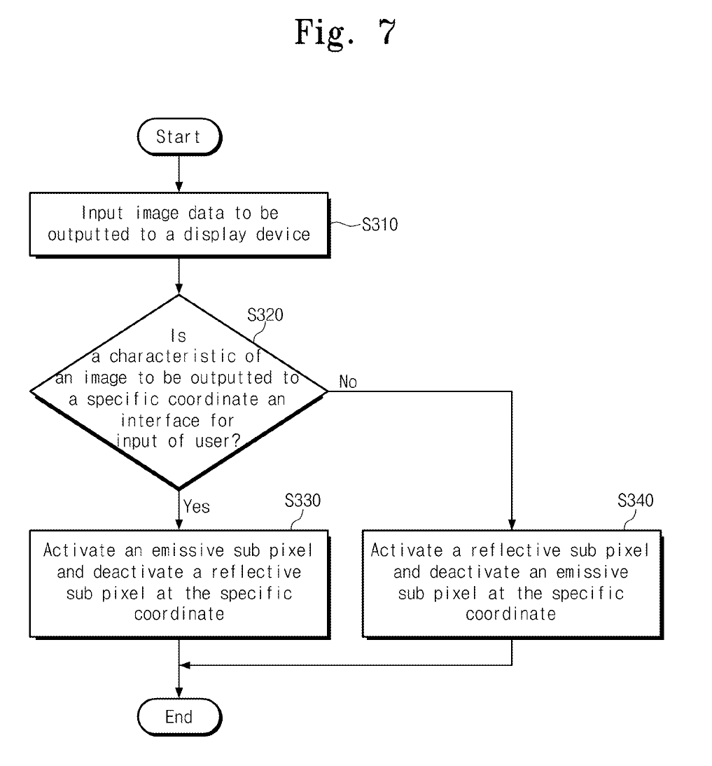

FIG. 7 is a detailed flowchart illustrating another screen displaying method according to other embodiment of the inventive concept. Particularly, FIG. 7 illustrates the case that a determination signal is generated by determining whether a characteristic of an image to be outputted to a specific coordinate is an interface for input of user or an ordinary standby screen.

In operation S310, image data to be outputted is inputted to a display device. The image data to be outputted may be provided from an external device such as a video card connected to the display device. The display device may receive image data to be outputted through an external input/output terminal.

In operation S320, it is determined whether a characteristic of an image to be outputted at a specific coordinate in a screen display area of the display device is an interface for input of user. According to whether the characteristic of the image to be outputted is an interface for input of user or an ordinary standby screen, a sub pixel to be activated is selected among a reflective sub pixel and an emissive sub pixel included in the display device. When the characteristic of the image to be outputted is an interface for input of user, the method proceeds to operation S330, and when the characteristic of the image to be outputted is an ordinary standby screen, the method proceeds to operation S340.

The operation S330 is performed when the characteristic of the image to be outputted to the specific coordinate is an interface for input of user. In the operation S330, the emissive sub pixel is activated and the reflective sub pixel is deactivated at the specific coordinate. The interface for input of user needs to be outputted instantly. Since the emissive sub pixel has fast response speed, it fits for outputting an interface of input of user.

The operation S340 is performed when the characteristic of the image to be outputted to the specific coordinate is an ordinary standby screen. In the operation S340, the reflective sub pixel is activated and the emissive sub pixel is deactivated at the specific coordinate. The emissive sub pixel has fast response speed, but it has high power consumption. Therefore, it is better that the reflective sub pixel having less power consumption is activated at a coordinate where an ordinary standby screen is outputted.

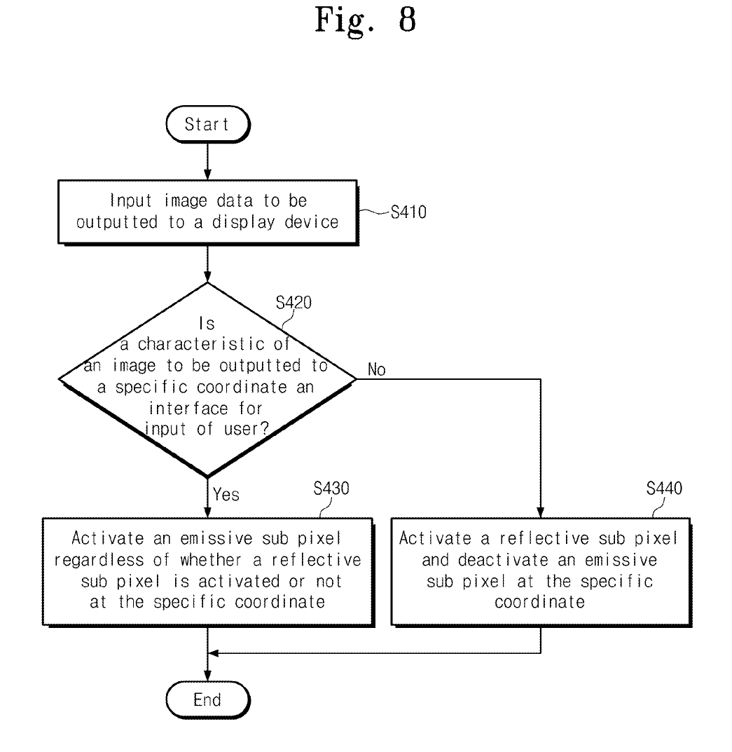

FIG. 8 is a detailed flowchart illustrating other screen displaying method according to other embodiment of the inventive concept. FIG. 8 also illustrates the case that a determination signal is generated by determining whether a characteristic of an image to be outputted to a specific coordinate is an interface for input of user or an ordinary standby screen. The embodiment of FIG. 7 illustrates the case that one of a reflective sub pixel and an emissive sub pixel is selectively activated. However, the embodiment of FIG. 8 illustrates the case that the reflective sub pixel and the emissive sub pixel are simultaneously activated.

In operation S410, image data to be outputted is inputted to a display device. The image data to be outputted may be provided from an external device such as a video card connected to the display device. The display device may receive image data to be outputted through an external input/output terminal.

In operation S420, it is determined whether a characteristic of an image to be outputted at a specific coordinate in a screen display area of the display device is an interface for input of user. When the characteristic of the image to be outputted is an interface for input of user, the method proceeds to operation S430, and when the characteristic of the image to be outputted is an ordinary standby screen, the method proceeds to operation S440.

The operation S430 is performed when the characteristic of the image to be outputted to a specific coordinate is an interface for input of user. In the operation S430, the emissive sub pixel is activated regardless of whether the reflective sub pixel is activated or not at the specific coordinate. That is, the reflective sub pixel and the emissive sub pixel may be simultaneously activated at a coordinate where an interface for input of user is outputted. In this case, the reflective sub pixels and the emissive sub pixels output different images. According to this case, when the reflective sub pixels and the emissive sub pixels are driven at different operating frequencies, user's inconvenience due to slow response speed of the reflective sub pixels may be relieved.

The operation S440 is performed when the characteristic of the image to be outputted to the specific coordinate is an ordinary standby screen. In the operation S440, the reflective sub pixel is activated and the emissive sub pixel is deactivated at the specific coordinate.

The inventive concept determines a characteristic of an image to be outputted at each coordinate to drive at least one of a reflective sub pixel and an emissive sub pixel. Therefore, the inventive concept reduces power consumption of a display device and provides an image characteristic requiring fast screen switching clearly.

According to embodiments of the inventive concept, power consumption of a display device may be reduced by outputting a still image or an ordinary standby screen through a reflective pixel. Additionally, a clear moving image and a fast response speed for input of user are provided by using an emissive pixel. That is, an image having high image quality is provided by properly controlling two display types.

The above-disclosed subject matter is to be considered illustrative and not restrictive, and the appended claims are intended to cover all such modifications, enhancements, and other embodiments, which fall within the true spirit and scope of the inventive concepts. Thus, to the maximum extent allowed by law, the scope of the inventive concepts is to be determined by the broadest permissible interpretation of the following claims and their equivalents, and shall not be restricted or limited by the foregoing detailed description.

What is claimed is:

1. A display device comprising:
a pixel array configured to include a reflective pixel unit including one or more reflective sub pixels and an emissive pixel unit including one or more emissive sub pixels, wherein the reflective pixel unit and the emissive pixel unit are combined to allow the reflective sub pixel and the emissive sub pixel to be included in one coordinate;
an image determination circuit configured to generate a determination signal according to a characteristic of an image to be outputted to each of the coordinates;
a gate driver configured to generate a gating signal for activating at least one of the reflective sub pixel and the emissive sub pixel in one coordinate based on the generated determination signal; and
a data driver configured to provide a driving signal to the pixel array by referring to image data to be outputted to each of the coordinates and the generated gating signal.

2. The display device of claim 1, further comprising a timing controller configured to control output of the image data to be outputted to each of the coordinates by distributing the generated determination signal and a signal corresponding to the image data into the gate driver and the data driver.

3. The display device of claim 1, wherein the data driver drives the reflective sub pixel at an operating frequency lower than that of the emissive sub pixel.

4. The display device of claim 1, wherein the determination signal is generated by determining whether a content of the image to be outputted to each of the coordinates is a still image or a moving image.

5. The display device of claim 4, wherein the reflective sub pixel is activated and the emissive sub pixel is deactivated at a coordinate where a still image is to be outputted, and the emissive sub pixel is activated and the reflective sub pixel is deactivated at a coordinate where a moving image is to be outputted, in response to the generated gating signal.

6. The display device of claim 1, wherein the determination signal is generated by determining whether a content of the image to be outputted to each of the coordinates is an interface for input of user or an ordinary standby screen.

7. The display device of claim 6, wherein the reflective sub pixel is activated and the emissive sub pixel is deactivated at a coordinate where an ordinary standby screen is to be outputted, and the emissive sub pixel is activated and the reflective sub pixel is deactivated at a coordinate where an interface for input of user is to be outputted, in response to the generated gating signal.

8. The display device of claim 6, wherein the reflective sub pixel is activated and the emissive sub pixel is deactivated at a coordinate where an ordinary standby screen is to be outputted, and the emissive sub pixel is activated regardless of whether the reflective sub pixel is activated or not at a coordinate where an interface for input of user is to be outputted, in response to the generated gating signal.

9. A screen displaying method comprising:
generating a determination signal by referring to a characteristic of an image to be outputted, with respect to each of coordinates of pixels of a display device;
generating a gating signal for activating at least one of a reflective sub pixel and an emissive sub pixel included in each of the coordinates based on the generated determination signal; and
activating at least one of the reflective sub pixel and the emissive sub pixel at each of the coordinates according to the generated gating signal.

10. The method of claim 9, wherein the reflective sub pixel is driven at an operating frequency lower than that of the emissive sub pixel.

11. The method of claim 9, wherein the determination signal is generated by determining whether a content of the image to be outputted to each of the coordinates is a still image or a moving image.

12. The method of claim 11, wherein the reflective sub pixel is activated and the emissive sub pixel is deactivated at a coordinate where a still image is to be outputted, and the emissive sub pixel is activated and the reflective sub pixel is deactivated at a coordinate where a moving image is to be outputted, in response to the generated gating signal.

13. The method of claim 9, wherein the determination signal is generated by determining whether a content of the image to be outputted to each of the coordinates is an interface for input of user or an ordinary standby screen.

14. The method of claim 13, wherein the reflective sub pixel is activated and the emissive sub pixel is deactivated at a coordinate where an ordinary standby screen is to be outputted, and the emissive sub pixel is activated and the reflective sub pixel is deactivated at a coordinate where an interface for input of user is to be outputted, in response to the generated gating signal.

15. The method of claim 13, wherein the reflective sub pixel is activated and the emissive sub pixel is deactivated at a coordinate where an ordinary standby screen is to be outputted, and the emissive sub pixel is activated regardless of whether the reflective sub pixel is activated or not at a coordinate where an interface for input of user is to be outputted, in response to the generated gating signal.
